(19) United States
(12) Patent Application Publication
(10) Pub. No.: US 2017/0130495 A1
(43) Pub. Date: May 11, 2017

(54) DUAL-HINGE CLOSURE WITH LATCHING IN HORIZONTAL DIRECTION

(71) Applicant: Tesla Motors, Inc., Palo Alto, CA (US)

(72) Inventors: David Wheeler, Pleasanton, CA (US); Steve Klotz, Fremont, CA (US); Ian Sadowski, San Francisco, CA (US); Nermin Mujcinovic, Livermore, CA (US); Noam Goldberg, Santa Cruz, CA (US); Robert Coleman Skelton, Santa Clara, CA (US); Andy Warburton, Pleasanton, CA (US); Adnan Esmail, Palo Alto, CA (US); Joshua Liu, Fremont, CA (US); Andy Wong, Palo Alto, CA (US); Padmanabhan Kumar, Fremont, CA (US); Jon Bennett, San Francisco, CA (US); John Hughes, Oakland, CA (US); Hemant Sikaria, Folsom, CA (US); Jacob Warman, San Francisco, CA (US); Chris Satkoski, San Jose, CA (US); Nicolas Altenburger, Los Altos, CA (US)

(73) Assignee: Tesla Motors, Inc., Palo Alto, CA (US)

(21) Appl. No.: 15/273,157

(22) Filed: Sep. 22, 2016

Related U.S. Application Data
(60) Provisional application No. 62/232,155, filed on Sep. 24, 2015.

(51) Int. Cl. E05C 9/10; E05C 9/20; E05C 9/14; E05D 11/06; E05B 83/36; B60J 5/04; E05B 55/00; E05B 81/04; E05B 81/18; E05B 83/16; E05C 1/08; E05D 11/08

(52) U.S. Cl. CPC E05C 9/10; E05C 1/085; E05C 9/20; E05C 9/14; E05D 11/06; E05D 11/082; B60J 5/042; B60J 5/0491; E05B 55/00; E05B 81/04; E05B 81/18; E05B 83/16; E05B 83/36

(57) ABSTRACT

A closure system for a vehicle comprises: a dual-hinge closure comprising a first portion hinged to the vehicle by a first hinge, and a second portion hinged to the first portion by a second hinge; a frame that at least in part surrounds an opening in the vehicle; an adjustable bump stop subassembly mounted to the first portion, wherein the adjustable bump stop subassembly rests on the frame when the first portion is in a closed position; and a latch system comprising a latch configured to engage a horizontal striker, the latch system configured so that an end of the second portion opposite the second hinge latches to and unlatches from a distal portion of the frame by essentially horizontal motion.

### CROSS-REFERENCE TO RELATED APPLICATION

The present U.S. Utility patent application claims priority pursuant to 35 U.S.C. §119(e) to U.S. Provisional Application No. 62/232,155, entitled “DUAL-HINGE CLOSURE WITH LATCHING IN HORIZONTAL DIRECTION”, filed Sep. 24, 2015, which is hereby incorporated herein by reference in its entirety and made part of the present U.S. Utility patent application for all purposes.

### BACKGROUND

The interaction between a vehicle and its driver (or passengers) is not limited to the situations where the vehicle is being driven, but also include the acts of getting into and out of the car including the loading and unloading of personal belongings or other cargo. The increasing use of key fobs that are automatically detected by the vehicle has aided some efforts toward an easier and more fully automated ingress and egress procedure.

Recently, the technology field of automated vehicle closures took a leap forward with the introduction, by Tesla Motors, of powered vehicle doors having multiple sections that move by way of dual hinges. For example, such a door can provide a significantly larger opening to the vehicle interior and therefore make it easier and more convenient for passengers to step into a second row and/or third row.

### SUMMARY

In a first aspect, a closure system for a vehicle comprises: a dual-hinge closure comprising a first portion hinged to the vehicle by a first hinge, and a second portion hinged to the first portion by a second hinge; a frame that at least in part surrounds an opening in the vehicle; an adjustable bump stop subassembly mounted to the first portion, wherein the adjustable bump stop subassembly rests on the frame when the first portion is in a closed position; and a latch system comprising a latch configured to engage a horizontal striker, the latch system configured so that an end of the second portion opposite the second hinge latches to and unlatches from a distal portion of the frame by essentially horizontal motion.

Implementations can include any or all of the following features. The closure system further comprises first electromechanical actuators for the first portion, and second electromechanical actuators for the second portion. The first electromechanical actuators extend between a distal end of the first portion and the frame at the first hinge. The second electromechanical actuators extend between a proximate end of the first portion and a proximate end of the second portion. The latch is mounted on the end of the second portion, and the horizontal striker is mounted on the distal portion of the frame. The closure system further comprises a striker assembly that comprises the horizontal striker and a wedge configured to engage a nose of the latch. The striker assembly comprises respective wedges on each side of the horizontal striker. The striker assembly comprises respective wedges above and below the horizontal striker. The striker assembly further comprises a spring element backing the wedge. The adjustable bump stop subassembly comprises a spacer, a bracket connected to the first portion, and an adjustment that adjusts the spacer with regard to the bracket. The adjustable bump stop subassembly further comprises at least one biasing element that biases the spacer. The biasing element is configured to bias the spacer toward the member. The adjustable bump stop subassembly further comprises a member that holds the spacer, the member having at least one foot that holds the biasing element against the bracket. The member is set to different heights depending on the spacer being adjusted, the member guided by bolts that hold the bracket to the upper portion. The closure system further comprises a shutface switch on an edge of the second portion, the shutface switch configured for controlling motion of the dual-hinge closure.

In a second aspect, a closure system for a vehicle comprises: a dual-hinge closure comprising a first portion hinged to the vehicle by a first hinge, and a second portion hinged to the first portion by a second hinge; a frame that at least in part surrounds an opening in the vehicle; first means, mounted to the first portion, for adjustably supporting the first portion in a closed position; and second means for latching and unlatching an end of the second portion opposite the second hinge to and from a distal portion of the frame by essentially horizontal motion.

Implementations can include any or all of the following features. The first means comprises an adjustable bump stop subassembly. The second means comprises a latch system including a latch configured to engage a horizontal striker. The latch is mounted on the end of the second portion, and the horizontal striker is mounted on the distal portion of the frame.

In a third aspect, a closure system for a vehicle comprises: a frame that at least in part surrounds an opening in the vehicle; a dual-hinge door comprising: an upper portion hinged to the vehicle by upper hinges at a proximate end of the upper portion; first and second upper electromechanical actuators that extend between a distal end of the upper portion and the frame at the upper hinges; adjustable bump stop subassemblies mounted to the upper portion, wherein the adjustable bump stop subassemblies rest on the frame when the upper portion is in a closed position; a lower portion hinged to the upper portion by lower hinges at an upper end of the lower portion; and first and second lower electromechanical actuators that extend between the proximate end of the upper portion and a proximate end of the lower portion; and a latch system configured so that the lower portion latches to and unlatches from the frame by essentially horizontal motion, the latch system comprising: a latch mounted on a lower end of the lower portion; a horizontal striker mounted on a lower end of the frame, the horizontal striker configured to horizontally fixate the lower portion when the latch is engaged to the horizontal striker; sliding wedges above and below a nose of the latch on each side of the horizontal striker, the sliding wedges configured to vertically fixate the lower portion when the latch is engaged to the horizontal striker; and spring elements that back the sliding wedges.

### BRIEF DESCRIPTION OF DRAWINGS

FIG. 1 shows an example of a dual-hinge closure in a closed position.

FIG. 2 shows an example of the dual-hinge closure in an open position.

FIG. 3 shows an example of a bump stop subassembly.

FIG. 4 shows an example of a horizontal striker assembly.

FIG. 5 shows an example of a nose of the latch engaged with the striker.

FIGS. 6A-D schematically show an example of a moving pattern for a dual-hinge closure.

FIG. 7 shows an example of a door control system.

FIG. 8 shows an example of a method where motion of a dual-hinge closure can be controlled based on a position of another closure.

FIG. 9 shows another example of a method where motion of a dual-hinge closure can be controlled based on a position of another closure.

FIG. 10 shows an example of a method where motion of a dual-hinge closure can be controlled based on an amount of time it has been open.

FIG. 11 shows an example of a method where motion of a dual-hinge closure can be controlled based on a closing envelope.

FIG. 12 shows an example of a method where automated motion of a dual-hinge closure can be initiated based on manual motion.

FIG. 13 shows an example of a method where motion of a dual-hinge closure can be controlled based on a force of contact with an obstacle.

FIG. 14 shows an example of a method where a user can be provided a touchscreen notice that an obstacle-stopped motion of a dual-hinge closure can be overridden.

FIG. 15 shows an example of a method where an obstacle-stopped motion of a dual-hinge closure can be overridden by holding an external or internal control.

FIG. 16 shows an example of a method where an obstacle-stopped motion of a dual-hinge closure can be continued after the obstacle moves away.

FIG. 17 shows an example of a method where motion of a dual-hinge closure can be controlled based on a force and duration of a tap on the dual-hinge closure.

FIG. 18 shows an example of a method where closing motion of a dual-hinge closure can be controlled using a shutface control.

FIG. 19 shows an example of a method where motion of a dual-hinge closure can be controlled using a shutface control.

FIG. 20 shows an example of a method where motion of a dual-hinge closure can be controlled using a touchscreen control.

FIG. 21 shows another example of a method where motion of a dual-hinge closure can be controlled using a touchscreen control.

FIG. 22 shows an example of a method where motion of a dual-hinge closure can be controlled based on determined conditions.

FIG. 23 shows another example of a method where motion of a dual-hinge closure can be controlled based on determined conditions.

FIG. 24 shows an example of a method where electric actuators of a dual-hinge closure can be controlled individually.

### DETAILED DESCRIPTION

This document describes systems and techniques for vehicle closures that provide more convenient access to the interior of a vehicle, such as to a passenger compartment. In some implementations, a dual-hinge door is arranged to have an improved opening and closing sequence. For example, when opening the door can first peel away from a latch at its lower edge, and only thereafter does the upper part begin moving; conversely on closing, the door can first come to rest on upper stops before rotating into the bottom latch in an essentially horizontal motion. That is, the door unwraps itself from, and wraps itself onto, the frame around the opening, rather than move in a gullwing-like pattern.

While doors are used as examples herein, they are not the only kind of structure that can be used. Rather, ideas described herein can be applied to other closures, including, but not limited to, hoods, trunk lids, liftgates, and roofs. Also, while examples describe a closure for an opening to second- and third-row seats, closures for any other openings of a vehicle are also contemplated. Finally, while a passenger vehicle such as a sport-utility or crossover vehicle is used as an example, other transportation devices are also contemplated, including, but not limited to, trucks, vans, buses, vessels, aircraft, trains, trams, and other transportation capsules. As used herein, the term vehicle includes any and all of such transportation devices.

In some examples herein, various components, or parts of components, are characterized as being an upper or lower one, or the proximal or distal one, of multiple instances. In other implementations, however, other nomenclature may be more appropriate. For example, a component, or a part of a component, can be characterized as being an inner or outer one, or as being the right or the left one. Therefore, the terms upper and lower are here used for illustrative purposes only.

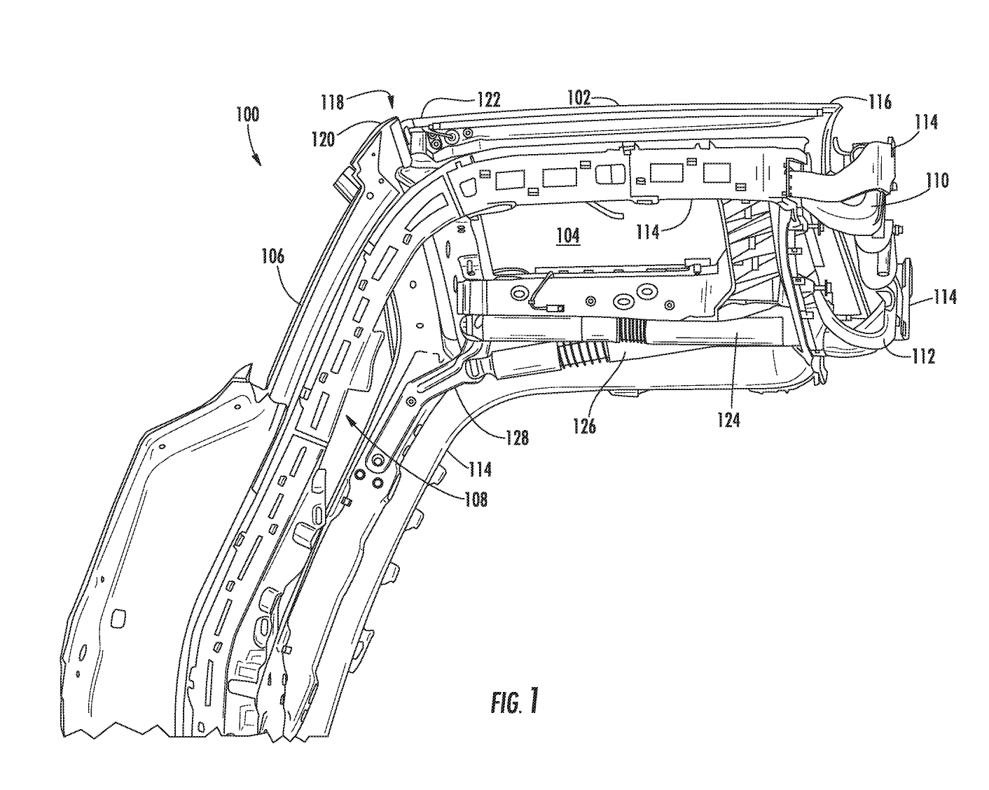

FIG. 1 shows an example of a dual-hinge closure 100 in a closed position. The dual-hinge closure has an upper portion 102. In some implementations, the upper portion is configured to form part of the vehicle's roof while in a closed position. For example, the upper portion has at least one window 104. The dual-hinge closure has a lower portion 106. In some implementations, the lower portion is configured to form part of the vehicle's side while in a closed position. For example, the lower portion has an opening 108 for at least one window. Each of the upper and lower portions can be made of any suitable material, for example as a cast component.

The upper portion is mounted to upper hinges 110 and 112. The upper hinges are connected to structure 114. For example, the structure is part of a frame such as the vehicle body. The other ends of the upper hinges are attached to the upper portion near a proximate end 116 thereof. The upper hinges allow the upper portion to rotate relative to the rest of the vehicle, for example between a closed position (e.g., as shown) and an open position.

The lower portion is attached to the upper portion by lower hinges 118. The lower hinges are attached to a proximate end 120 of the lower portion and to a distal end 122 of the upper portion. The lower hinges allow the lower portion to rotate relative to the upper portion.

An upper actuator 124 for the upper portion and a lower actuator 126 for the lower portion are shown here. In some implementations, more than one actuator can be used for at least one of the door portions. For example, a pair of actuators can be positioned on each side of the window 104. The upper actuator is attached to the vehicle frame at the proximal end 116, and to the upper portion near the distal end 122 thereof. The lower actuator is attached to the upper portion near the proximal end 116 thereof, and to the lower portion near its proximal end 120. For example, the lower actuator can act on the lower portion by way of a bracket 128.

Each of the actuators can use any suitable technique for extension and contraction so as to effectuate rotation of the corresponding door portion (here, upper or lower) about its respective hinge(s) (here, upper or lower). In some implementations, linear electromechanical actuators can be used. For example, such actuators can be energized using a controller and can allow obstacle detection my monitoring the power (e.g., amount of current) required to move the actuator in either direction.

FIG. 2 shows an example of the dual-hinge closure 100 in an open position. The rest of the vehicle is here not explicitly shown for simplicity, but the vehicle can include, for example, a vehicle rear section 200, a vehicle interior 202 and a front door area 204. That is, in this example the dual-hinge closure provides access to at least a second row of passenger seats in the vehicle interior 202, and optionally also to one or more third-row seats that can be positioned toward the vehicle rear section 200.

The upper actuators 124 are here more extended than in the previous illustration, which results in the upper portion 102 having been rotated relative to the vehicle so as to instead be in an open position. This can correspond to a maximum extension of the upper actuators, or a partial extension. The lower actuators can be in a predefined position relative to the upper position. In some implementations, this can correspond to a more inward, or more outward, rotation relative to the upper portion than in the closed position shown above. For example, the position of the lower portion can here be set based on whether any overhead obstacle has been detected. The structure 114 which can be part of the vehicle's frame here defines an opening 206 into the vehicle interior 202. Accordingly, when the dual-hinge closure is in the open position a passenger can move into or out of the vehicle interior.

The dual-hinge closure 100 can have one or more controls for managing its position and/or motion. In some implementations, a shutface control 208 is provided in a shutface area 210 of the dual-hinge closure. The shutface area is hidden when the door is in the closed position, but can become accessible in one or more open positions. For example, the control can include a switch (e.g., actuated by a pushbutton) and can be positioned on a part of the shutface area that is on the lower portion 106 of the door.

The upper portion 102 has one or more bump stop areas 212. In some implementations, the upper portion can here have a bump stop configured for adjustably positioning the upper portion in its closed position. For example, this can allow adjustment of the resting height of the upper portion to be made flush with nearby areas of the roof (e.g., an adjoining glass panel).

The dual-hinge closure can be latched to the vehicle using one or more latches. For example, a latch system of a latch and a corresponding striker can be allocated between the vehicle frame and the door. In some implementations, a latch 214 is provided on the lower portion. For example, the latch can be positioned near a distal end 216 of the lower portion. A striker area 218 of the vehicle frame can be provided on the structure 114, such as at a lower end thereof. The latch can be operated automatically and/or manually.

Special precaution can be taken in an attempt to reduce the likelihood that a person or another obstacle becomes pinched by the dual-hinge closure in motion. In some implementations, the space between the dual-hinge closure and the front door area 204 can be taken into account. For example, a collision zone 220 (here schematically illustrated) can be defined as a two-or three-dimensional space based on a particular position of either door. The zone can be defined taking into account respective swing patterns of the dual-hinge closure and the front door. In some implementations, the front door is (also) powered and can be configured to automatically assume positions, such as a closed position and multiple open positions corresponding to opening angles. For example, the front door can be configured so that when it is open it does not stop at an opening angle less than a predefined value. This can seek to avoid pinching situations between the front door and the dual-hinge closure.

Here, only one of the dual-hinge door is shown for simplicity. In some implementations, more than one such closure can be used on a vehicle. For example, the vehicle can have multiple closures along one side, and/or closures on opposite sides of the vehicle, and/or closures at the front or rear.

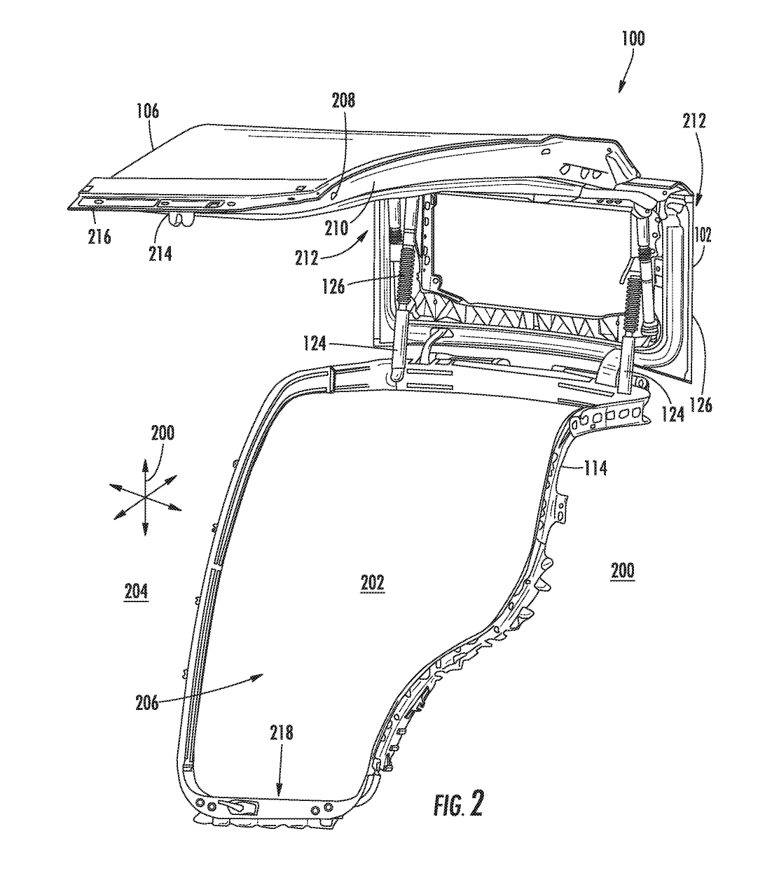

FIG. 3 shows an example of a bump stop subassembly 300. This subassembly can be mounted to the upper portion of the dual-hinge closure—for example at either or all of the bump stop areas 212 (FIG. 2). There, the subassembly can be used for adjustably supporting the upper portion in a closed position.

The subassembly includes a bracket 302 that here has essentially an L-shaped profile. The upright portion of the bracket is attached to the structure of the upper portion by bolts 302. The lateral portion of the bracket provides the surface that will be the support for the upper portion in its resting position. A spacer 306 can be positioned adjacent the lateral portion of the bracket. The spacer can be used to set the resting height of the upper portion, such as by way of adjustments 308 that operate through the lateral portion.

The spacer 306 (e.g., made of a resilient material such as rubber) can be mounted on a member 310 which can have respective slots for the bolts 304 so as to be adjustable relative to the bracket 302. In some implementations, the member has a back portion that is essentially parallel with the upright portion of the bracket 302. From the back portion, the spacer can extend on one side of the lateral portion; on the other side, feet 312 can extend from the back portion. The feet can bear on springs 314 or any other biasing elements that also act on the bracket. As such, the spacer 306 can be biased toward the bracket at every setting of the adjustments 308. The subassembly can be at least partly covered by a finisher 316, here shown transparently for clarity. For example, the finisher can include a weather strip or other seal.

FIG. 4 shows an example of a horizontal striker assembly 400. The term horizontal is here used to signify that the motion of latching to or unlatching from this assembly occurs by substantially horizontal motion, here schematically illustrated by a path 402. For example, the path can be linear or slightly curved, such as when the latch (or the striker) is positioned some distance away from a point of rotation, such as a lower hinge of a dual-hinge closure.

The assembly 400 includes a striker 404. The striker will be engaged by a latch to secure the lower portion, and thereby the rest of the dual-hinge closure, in a horizontal position. Fixation of the door in another direction can also be provided. One or more upper sliding wedges 406 and/or lower sliding wedges 408 can be provided. A sliding wedge can be provided both above and below the striker. A sliding wedge can be provided on either or both sides of the striker. In some implementations, the sliding wedges engage the latch to ensure a rigid up and down position of the closure. For example, the wedges can be configured to maintain a tight fit with the latch housing under all tolerance conditions. The wedges can be made of any suitable material, including, but not limited to, a plastic material. The wedges are here backed by a spring element 410. For example, the spring element can be made of rubber and serve as a bumper for the wedges. A bracket 412 can be used for attaching the striker and/or for supporting the wedge(s) or the spring element.

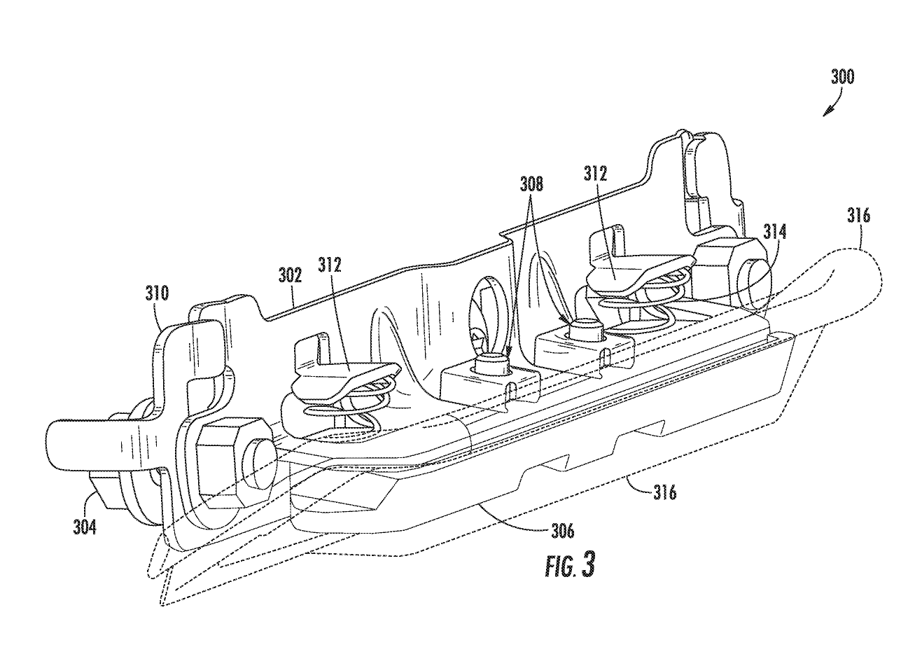

FIG. 5 shows an example of a nose 500 of the latch 214 engaged with the striker. Here, the nose has entered into the bracket 412, guided by the sliding wedges 406 and 408, and there engaged the striker so as to be latched in place. In some implementations, the latch is positioned on the moveable structure and the striker can be fix. For example, the latch can be mounted on the lower portion of the dual-hinge closure and the striker can be mounted to the overall vehicle structure, such as to a frame thereof. That is, the latch system here provides latching and unlatching of an end of the lower portion to and from a portion of the vehicle frame by essentially horizontal motion. This allows the lower portion, and thereby the rest of the closure, to be actuated to a full home position by actuation of the latch and the cinching latch mechanism. That is, when the latch is engaged, the lower portion is restricted against both horizontal and vertical motion so as to provide a tight attachment to the body.

A connection 502 can extend between the latch and a latch actuator, such as an electrically powered unit positioned elsewhere on the closure (e.g., in the interior thereof). Latching and unlatching can be initiated from a remote location, such as by a door controller or another vehicle controller. A connection 504 can extend between the latch and a manual actuator, such as a door handle or other grip. For example, this can allow a person to unlatch the closure when a power system has been deactivated or is otherwise not working, such as in the event of a power failure.

FIGS. 6A-D schematically show an example of a moving pattern 600 for a dual-hinge closure 602. In some implementations, the moving pattern is applied to any or all dual-hinge closures described herein. For example, the moving pattern is here an opening sequence.

The dual-hinge closure 602 here includes a portion 604 that is rotatably coupled to the vehicle body by a hinge 606. In the closed position that is shown in FIG. 6A, the portion 604 is substantially flush with a surface 608 on the outside of the vehicle, such as a roof line. A portion 610 of the dual-hinge closure is rotatably coupled to the portion 604 by a hinge 612. A striker assembly 614 is here positioned toward the free end of the portion 610. The portions 604 and 610 have corresponding actuators to effectuate rotation about the hinges 606 and 612, respectively. The portion 604 has a bump stop 614 that currently rests on structure 616 of the vehicle's body.

FIG. 6A shows the closure in a closed position. For example, the portion 610 is here latched to the vehicle body as may be the case, say, when the vehicle is traveling or parked. When a person should enter or exit the vehicle, however, an opening sequence can be initiated. For example, this is triggered by actuating a control inside or outside the vehicle, or by detection of the presence, in the near vicinity of the closure, of a wireless component belonging to the driver.

In response to the signal to begin the opening sequence, one or more actions can be performed. The latch can be released so as to unlatch the free end of the portion 610 from the vehicle. The actuator(s) for the portion 604 can be energized to hold the portion 604 against the vehicle body—here to hold the bump stop 614 against the structure 616. The actuator(s) for the portion 610 can be energized to open that portion so as to clear the latch and striker from each other in a substantially horizontal direction. For example, this rotation can be on the order of a few degrees and can reduce wear on seals around the opening by avoiding lateral movement between the parts that are sealed to each other.

FIG. 6B shows that the portion 610 has rotated away from the vehicle somewhat without the portion 604 being moved. To a person inside the vehicle, such as in a seat next to the closure, the outward movement of a part of the portion 610 can be preferable to, say, a motion substantially in an upward direction. This motion can be part of an opening sequence that allows the closure in a sense to peel away from the vehicle rather than open in a gullwing-like fashion. The motion can be conditioned on the absence of any obstacles. This can include that no potential obstacles are detected (such as by a sensor that ranges some distance away) and also that no actual obstacles are hit by the closure (such as by determining that no undue force is necessary to move the actuators).

The rotation of the portion 610 away from the vehicle can be temporarily stopped at about the position indicated in FIG. 6B. At or about the same time, the actuator(s) for the portion 604 can be energized so as to rotate that portion away from the vehicle. Also, the actuator for the portion 610 can be energized to rotate the portion 610 toward the vehicle. This can serve to reduce the footprint of the closure during the opening sequence, for example to allow opening in a narrow space. In a sense, the closure can be made to hug the side of the vehicle while opening.

FIG. 6C shows the dual-hinge closure 602 as the actuators are rotating the portion 604 away from the vehicle and the portion 610 toward the vehicle. The bump stop 614 is currently not resting on the structure 616. At a predefined point during this phase of the opening pattern, the rotation about the hinge 612 reaches a minimum angle and is therefore stopped. That is, the portion 610 then temporarily stops rotating toward the vehicle. This can occur while the portion 604 continues to be rotated away from the body.

After the inward rotation of the portion 610 is stopped, the portion 610 can instead be rotated outward. For example, this can allow the free end of the portion 610 to clear the structure 616 or other part of the vehicle body. This outward rotation can occur while the portion 604 continues to be rotated away from the body. FIG. 6D shows the dual-hinge closure 602 in an open position. The portions 604 and 610 can currently be stationary relative to each other and the rest of the vehicle. For example, the hinge 606 and/or the hinge 612 can currently be at an end of its rotation.

A closing pattern of the closure 602 can occur in essentially the reverse order. In some implementations, this is triggered by a corresponding signal, such as from a switch or other control, or by way of a wireless device. That is, the actuator(s) can be energized so that the portions 604 and 610 being rotating toward the vehicle about their respective hinges. This can continue until the portion 610 reaches a minimum angle where it ceases rotating about the hinge 612. The upper portion 604 can continue rotating about the hinge 606 until it reaches a stop position. During some or all of this rotation, the portion 610 can instead be rotated away from the vehicle. The rotation of the portion 604 toward the vehicle stops when the bump stop 614 rests against the structure 616. Thereafter, the portion 610 can instead begin rotating toward the vehicle so as to engage the striker assembly 614 and therefore latch onto the vehicle body from essentially a horizontal direction. That is, a closing sequence can be characterized as the dual-hinge closure wrapping itself onto the structure 616 (by way of the bump stop 614) and finally latching at the free end.

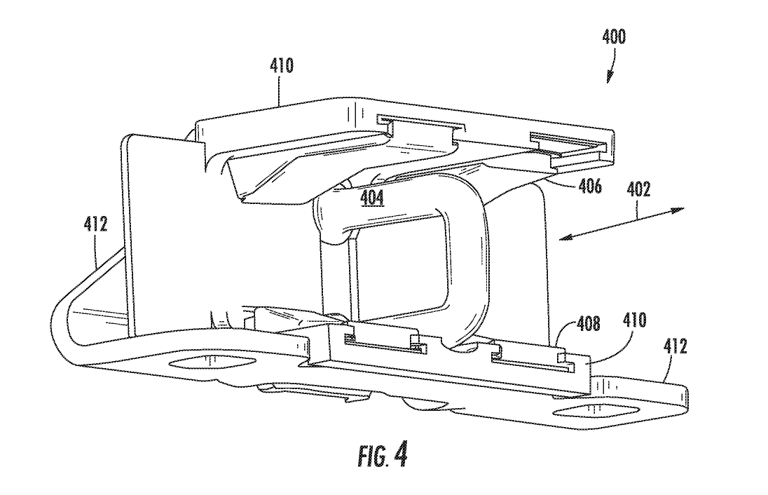

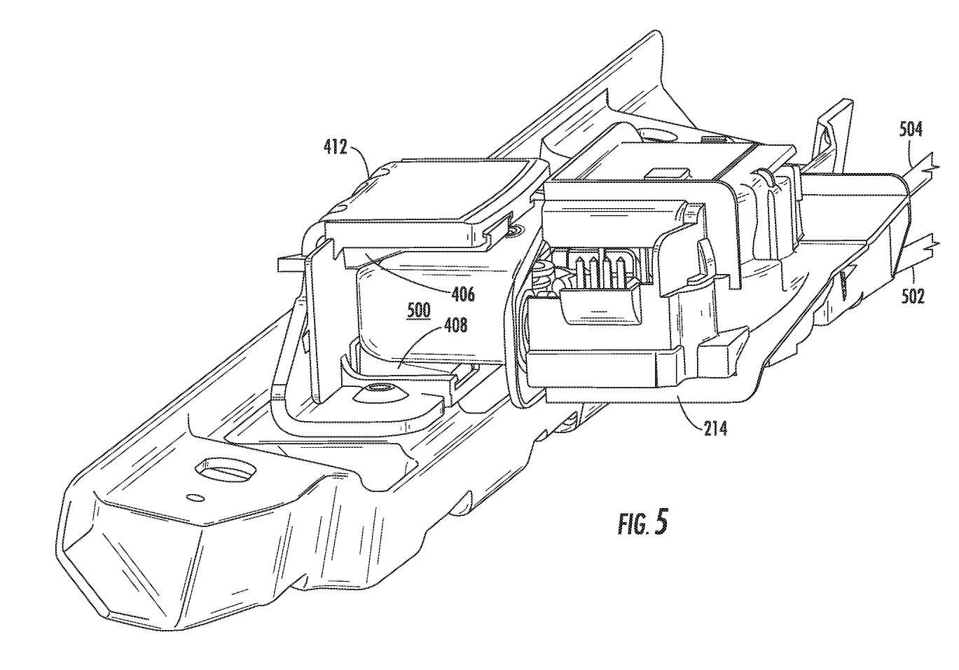

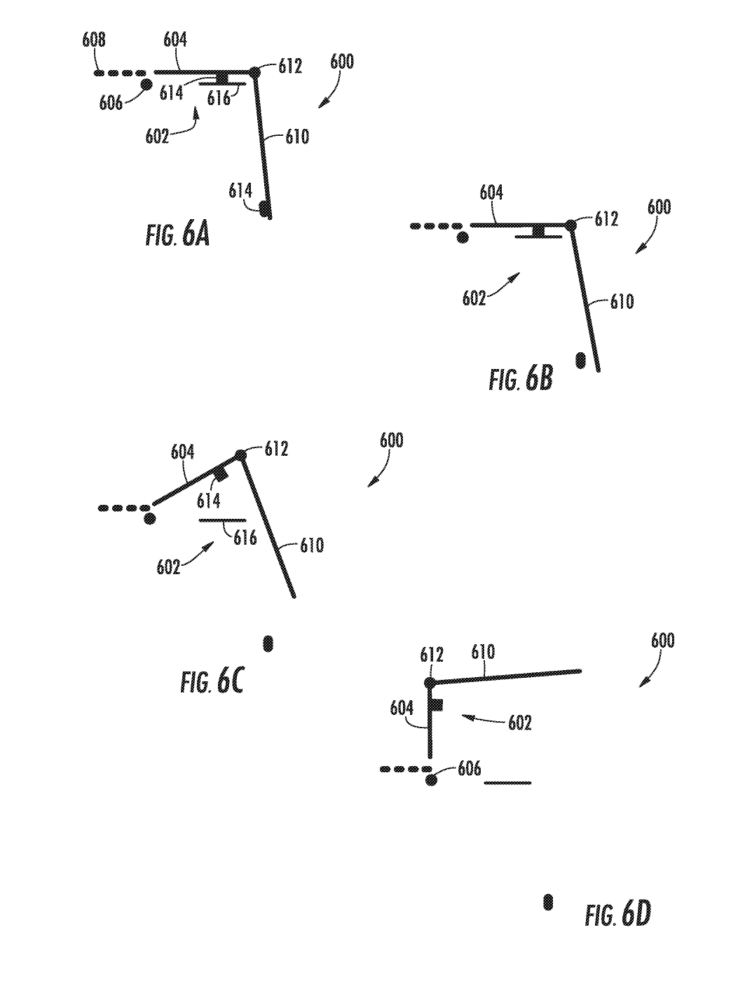

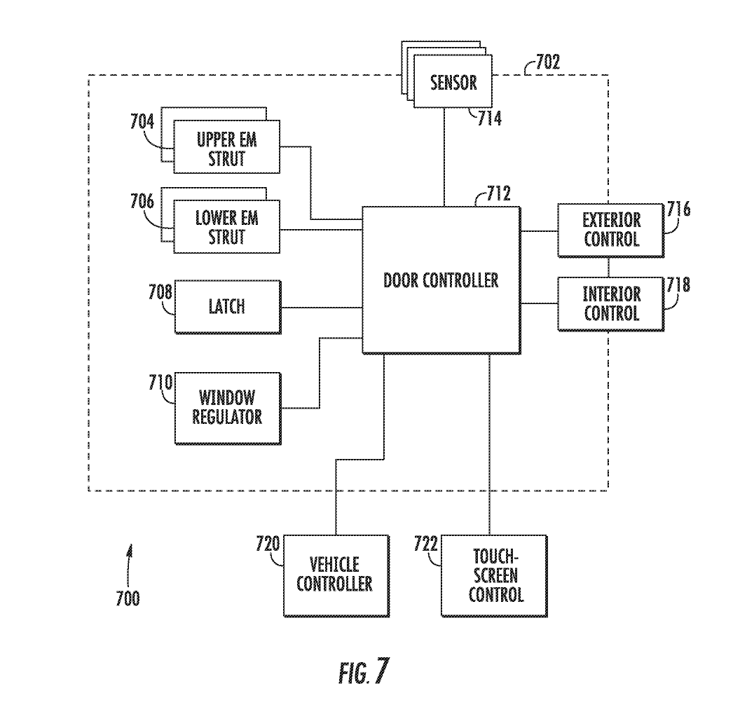

FIG. 7 shows an example of a door control system 700. A door 702 (or another type of closure) is schematically indicated. The door here has upper electromechanical struts 704, lower electromechanical struts 706, a latch 708 and a window regulator 710. These and other components are connected to, and controlled by, a door controller 712. In some implementations, the controller includes a dedicated processor or integrated circuit that is specifically designed to control the operation of the associated door. For example, software, firmware or other instructions, and/or operating parameters, can be stored in a memory accessible to the controller. Local instructions/information stored in the vehicle can be updated using a remote system, for example as an over-the-air firmware update. The controller can respond to signals or other inputs, made by a component, by an operator or by another processor, and can thereby be triggered to take one or more actions, for example those described herein.

The door control system 700 includes sensors 714 connected to the door controller. In some implementations, one or more of the sensors are positioned on the door 702, and one or more sensors are positioned elsewhere. For example, a sensor can be positioned on or inside another door on the vehicle or on the vehicle's roof. Any suitable type of sensor can be used, including, but not limited to, an ultrasonic sensor.

Input from one or more of the sensors can determine how the controller should operate the door (e.g., by way of a motor and/or hydraulics) in particular situations. For example, and without limitation: a latch sensor can indicate whether a door latch is currently latched; one or more position sensors can indicate the current position of the door (or of respective sections thereof, when the door has multiple hinged parts); a pinch sensor can indicate whether the door is pinching any obstacle (e.g., a person, animal or an object) against the frame of the door opening; one or more position sensors can indicate whether any obstacle is obstructing the door's intended path, and one or more motor sensors can indicate the speed and/or electric current of the motor.

The door control system 700 can include one or more exterior controls 716 and/or one or more interior controls 718. In some implementations, one or more of the controls are positioned on the door 702, and one or more controls are positioned elsewhere.

In some implementations, an exterior control includes a touch sensitive surface on the outside of the door. Such surface can appear similar to a door handle, but does not necessarily include any moving parts. Rather, the signal generated upon a person touching the surface can be used to trigger certain operations by the door controller. In some implementations, the vehicle can activate the external door control upon detecting that an authentication device (e.g., a key fob or a smartphone) is outside the vehicle within a predefined distance or area. After the door control has been activated, it can detect an input that a person makes. This prevents the door from being opened (or closed) by an unauthorized person. For example, the person can press on or touch a touch sensitive handle or other button.

An interior control can for example be located on an interior panel that covers the vehicle's B-pillar behind the first-row seats. The control can therefore be accessible to a passenger in the second-row seat, and also to a person in the front-row seat.

Some examples herein refer to a switch being used to effectuate the movement of a dual-hinge closure. However, any type of controls are contemplated, including touch-sensitive controls (such as a capacitive switch) and a virtual control on a display (such as a touchscreen).

The door control system 700 can also have a connector to a car harness or other bus. For example, such connection can provide the device with electric connection (e.g., 12V battery power and ground) as well as with communication (e.g., in form of a bus for communication according to the CAN or LIN standards).

The door controller 712 is here connected to a vehicle controller 720. The vehicle controller 720 can be in charge of the overall behavior and functionality of the vehicle. This can facilitate interaction between the door controller and the main control system for the vehicle, for example such that the door controller can take into account other aspects of the vehicle's operation. The connection can be made by any type of bus in the vehicle. In some implementations, the bus provides power and ground contact for the door control system 700, and communication between the respective systems.

The vehicle controller can include a wireless component configured to interact with an authentication device, such as a key or a key fob carried by the driver. When the vehicle's control system (e.g., the security control component 724) detects that the authentication device is near the outside of the vehicle, certain vehicle functions can be activated (or deactivated). For example, one or more doors or other closures can be opened, provided that no sensor indicates any obstacle in a relevant area. In some implementations, the authentication device is not a key or a key fob, but rather can be a smartphone (e.g., compatible with a particular operating systems for portable communication devices) and can therefore be equipped with an application that is tailored to the particular vehicle (e.g., by being provided by the vehicle's manufacturer) so as to configure the smartphone (or other mobile device) to be recognized by the vehicle.

The door control system 700 can be connected to a touchscreen control 722. In some implementations, the touchscreen control provides information about the status of closures in the vehicle, and/or controls for initiating, controlling or stopping the motion of any such closure. For example, the touchscreen can be positioned in a vehicle dashboard so as to be accessible to the driver or a front seat passenger. Other locations can be used.

Each of the vehicle's doors or other closures can have a corresponding door control system door control system 700. Two or more of these can interact with each other, or with the vehicle controller 720, from time to time. In some implementations, the door control system 700 controls one of the vehicle's respective second-row doors, whereas a corresponding door control system can control another closure, such as a front-row door on the same side of the vehicle. For example, the corresponding door control system for a front door can provide for power opening and closing of such door. Before moving the door 702, and during such motion, the door control system 700 can take into account the position (or other aspect) of the front door. For example, the door control system 700 can avoid that the door 702 enters a collision zone defined with regard to the two doors.

In the following, some illustrations of operations by a dual-hinge closure will be described. Such operations can be effectuated by a controller (e.g., the door controller 712 in FIG. 7) using one or more actuators (e.g., the actuators 124 and 126 in FIG. 1). Absent special circumstances, the closure can follow the same path when closing as when opening. Also, the door controller can be configured so that the closure only opens while the vehicle is stationary, and so that closing is initiated only if the vehicle is stationary. As an example of a modified motion sequence, the door controller can be configured so that the closure opens in a narrowest mode unless an overhead obstacle is detected, otherwise the upper portion of the closure can stop opening and the lower portion can be extended outward from the vehicle.

Operations are schematically illustrated as steps in the processes, but in some implementations two or more of the steps can be performed in a different order. More or fewer steps than those shown can be performed. More than one of the processes can be part of the functionality of an individual closure. The processes can then be performed in a partially or fully overlapping manner. It is contemplated that one or more operations from a process can be performed within any of the other processes. As another example, a process is not necessarily performed in its entirety each time. Rather, a system can be configured so that only parts of a process, such as one or more steps, is performed in a particular situation.

FIG. 8 shows an example of a method 800 where motion of a dual-hinge closure (DHC) can be controlled based on a position of another closure. At 810 it is determined that a front door is open. For example, this is done using one or more sensors and/or a vehicle controller. At 820, it is determined that the front door is open to an angle narrower than a predefined angle A. For example, the front door can be power operated and configured to not be automatically placed in positions where the angle is less than A, but a person may have manually pushed the door into such position. At 830, the DHC is moving, for example as a result of a signal generated using a control. The determination made at 820 is taken into account in controlling the motion of the DHC. At 840, the DHC is stopped at the collision zone defined with regard to the front door. For example, if the DHC was being closed, it can stop its inward motion.

FIG. 9 shows another example of a method 900 where motion of a dual-hinge closure can be controlled based on a position of another closure. At 910, the DHC stops due to the front door. For example, this can occur because the DHC is about to enter a collision zone defined with regard to the front door. At 920, the front door is moved. This can be an automated motion or be done by a person. At 930, the DHC begins moving following the movement of the front door. In some implementations, this occurs only if the front door stopped within a predefined time (e.g., a few seconds) after the DHC was stopped. For example, the DHC can continue its previous motion (e.g., a closing sequence).

FIG. 10 shows an example of a method 1000 where motion of a dual-hinge closure can be controlled based on an amount of time it has been open. At 1010, the DHC is opened. For example, the DHC is power opened to its fully open position. At 1020, it is determined an amount of time that has elapsed since the door was opened. At 1030, the DHC is closed as a result of a signal generated using some control. In some implementations, the closing depends on the determined amount of time. If the DHC had remained open less than a predetermined amount of time (e.g., on the order of one or more hours) the DHC can close according to a normal mode. For example, in the normal mode it is sufficient to press or otherwise actuate the control once to effectuate the closing sequence. On the other hand, if the DHC had remained open for at least the predetermined amount of time, the DHC can close according to a calibration mode. For example, in the calibration mode the control is continuously pressed or otherwise actuated to effectuate the closing sequence.

FIG. 11 shows an example of a method 1100 where motion of a dual-hinge closure can be controlled based on a closing envelope. At 1110, the DHC is opened, and at 1120, the DHC is manually moved. For example, this can involve pushing either or both portions of the DHC in any direction. The controller can be configured to allow such manual adjustments and then hold the closure in the new position. At 1130 an input is received to open or close the DHC. For example, this input can be generated using any control. At 1140, the closing envelope and the opening envelope of the DHC are compared. For example, this involves determining whether the DHC upon closing will occupy a larger footprint above the ground, and/or reach higher above the vehicle, than during an opening sequence. If so, the DHC can be returned to a previous position (e.g., the one before the manual moving) at 1150. At 1160, the DHC is opened or closed corresponding to the input received at 1130.

FIG. 12 shows an example of a method 1200 where automated motion of a dual-hinge closure can be initiated based on manual motion. At 1210, the DHC is manually moved. For example, a person pushes or pulls on any part of the DHC in any direction. At 1220 it is determined whether the DHC has been manually moved more than a predefined movement threshold (such as a certain angle of rotation about a hinge). If so, an opening or closing sequence is initiated at 1230. For example, the DHC is then automatically moved in the direction that it was being manually moved.

FIG. 13 shows an example of a method 1300 where motion of a dual-hinge closure can be controlled based on a force of contact with an obstacle. At 1310 the DHC is moving. At 1320 an obstacle is contacted. For example, the contact can be detected using a pinch sensor on the DHC or on the vehicle body, or by detecting that undue force is required to move the DHC, such as based on monitoring the current that is driving electromechanical actuators. At 1330 the force exerted on the obstacle is determined or otherwise ascertained. For example, the force can be estimated based on sensor input and/or by gauging the power applied to the actuators. At 1340 the force (or another measure indicative thereof) is compared to a threshold. At 1350 the DHC is stopped before the force reaches the predefined threshold. For example, whenever the DHC is moving the force determination can be performed essentially in a continuous fashion and be constantly compared to the threshold. When the determined force suddenly increases this can be interpreted as having contacted an obstacle. That is, the stopping at 1350 is then performed to avoid significant harm to the obstacle.

FIG. 14 shows an example of a method 1400 where a user can be provided a touchscreen notice that an obstacle-stopped motion of a dual-hinge closure can be overridden. At 1410, the DHC is moving. At 1420, an obstacle is contacted and/or detected. For example, contact with the obstacle can be determined similarly to as described above. Moreover, an obstacle can instead or in addition be detected in another way, such as by an echo received by an ultrasonic sensor. At 1430, the DHC is stopped in response to the contact/detection. At 1440, an alert is presented on a touchscreen or any other information device. In some implementations, the alert can report that an obstacle has been contacted/detected and can provide a control for overriding the automated stop.

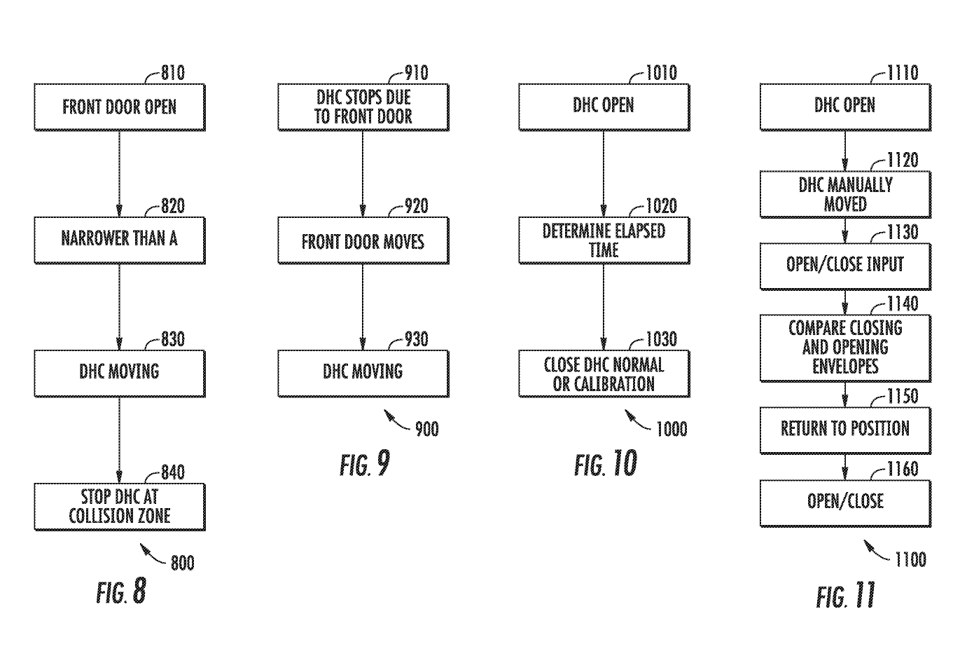

FIG. 15 shows an example of a method 1500 where an obstacle-stopped motion of a dual-hinge closure can be overridden by holding an external or internal control. At 1510 the DHC is being opened. At 1520, an obstacle is contacted and/or detected. At 1530, the DHC is therefore stopped. For example, this can be accompanied by a suitable alert to the driver or other passenger. At 1540 at least one input control, such as an external or internal switch, is continuously actuated by the person. At 1550, the opening of the DHC continuous based on such input. For example, this can allow a person to continue opening or closing the DHC if the person knows that no damage is being done, such as if the DHC moves into contact with vegetation that can safely be pushed out of the way by the DHC. At 1560, the person releases the input control, and the DHC is therefore stopped at 1570.

FIG. 16 shows an example of a method 1600 where an obstacle-stopped motion of a dual-hinge closure can be continued after the obstacle moves away. At 1620 the DHC is moving. This can be done in response to an input using an internal or external switch. At 1620 an obstacle is detected, for example using an ultrasonic sensor. The DHC is therefore stopped at 1630. In some implementations, the system tracks the amount of time that passes after the obstacle is detected. For example, if the obstacle is moved out of the detection zone within a predefined time (e.g., on the order of a few seconds) the system can deem it appropriate to continue the interrupted motion. At 1650, the movement can therefore be continued based on the determination of elapsed time.

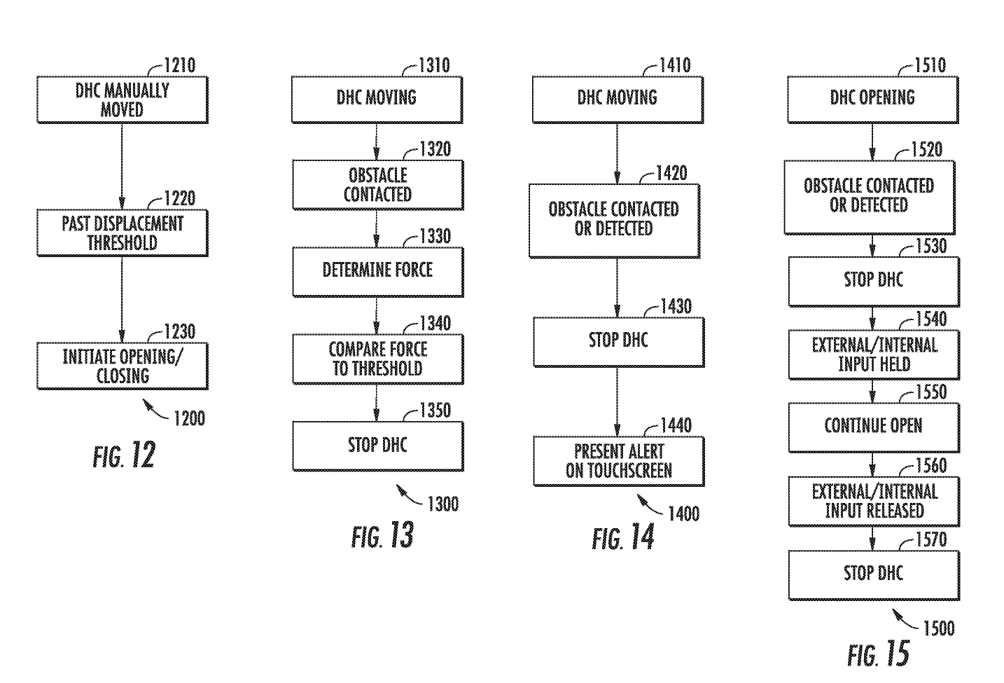

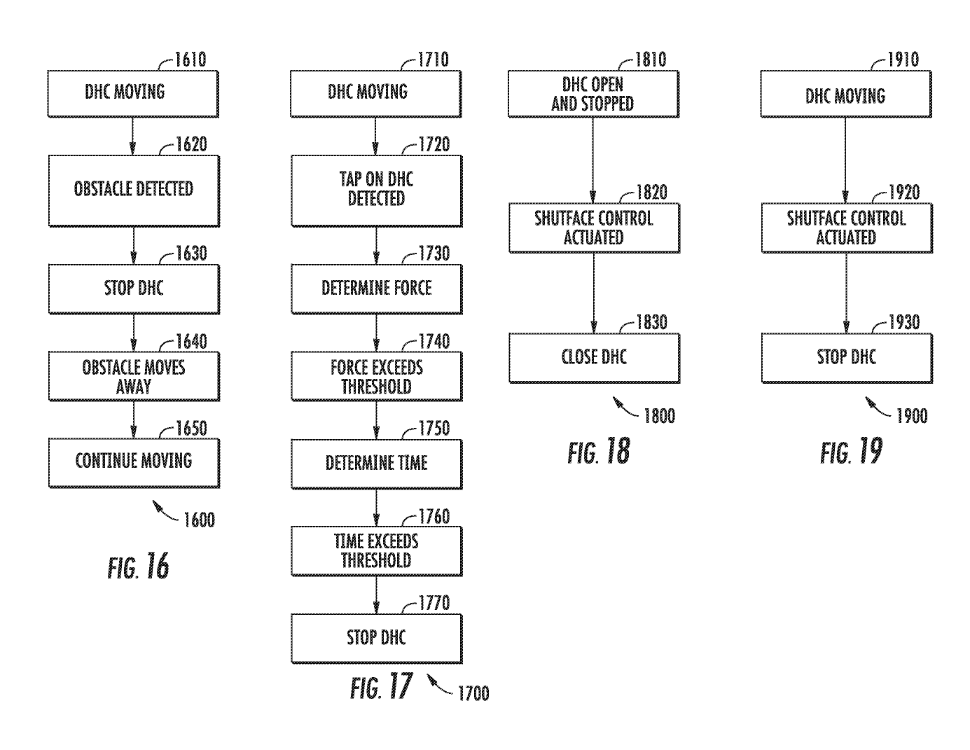

FIG. 17 shows an example of a method 1700 where motion of a dual-hinge closure can be controlled based on a force and duration of a tap on the dual-hinge closure. At 1710 the DHC is moving. At 1720 a tap on the moving DHC is detected. For example, this is done by a person inside or outside the vehicle. At 1730 the force of the tap is determined or otherwise ascertained, such as according to the examples above. At 1740 the force or other measure is compared with a threshold (e.g., a value on the order of tens of Newton). The duration of the threshold force is determined at 1750 and is compared with a time threshold (e.g., on the order of hundreds of milliseconds) at 1760. If the detected tap exceeded the force threshold for at least the predefined time then the DHC can be stopped at 1770.

FIG. 18 shows an example of a method 1800 where closing motion of a dual-hinge closure can be controlled using a shutface control. At 1810, the DHC is fully or partly open and is currently not in motion. At 1820 a person actuates a shutface control on the DHC. For example, the person can press the shutface control 208 (FIG. 2). At 1830 the DHC is closed based on the input from the shutface control.

FIG. 19 shows an example of a method 1900 where motion of a dual-hinge closure can be controlled using a shutface control. At 1910 the DHC is moving. At 1820 a person actuates a shutface control on the DHC while the DHC is in motion. The DHC is stopped at 1830 in response to the input.

FIG. 20 shows an example of a method 2000 where motion of a dual-hinge closure can be controlled using a touchscreen control. At 2010 a control is presented on a touchscreen. For example, the touchscreen can be located in the dashboard of the vehicle. At 2020 an input generated using the presented control is received. For example, a person touches the control because he or she wishes to open or close the DHC. At 2030 the DHC is opened or closed based on the received input. For example, if the DHC was initially open then the control allows it to be closed, and vice versa.

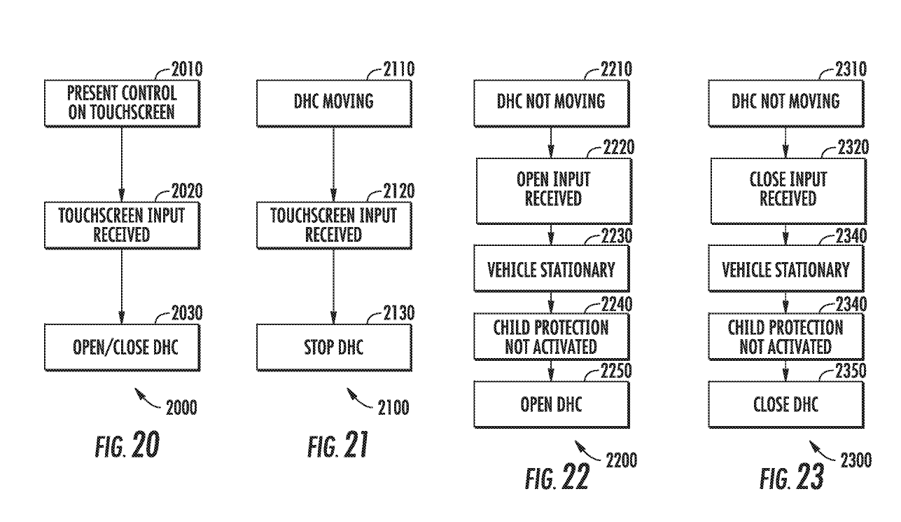

FIG. 21 shows another example of a method 2100 where motion of a dual-hinge closure can be controlled using a touchscreen control. At 2110 the DHC is moving. For example, this can be the result of an input using an internal or external input control. At 2120 an input generated using a control presented on a touchscreen is received while the DHC is in motion. At 2130 the DHC is stopped based on the touchscreen input. For example, this allows a person in the front seat to interrupt an opening or closing of the SHC that may have been initiated by another person.

FIG. 22 shows an example of a method 2200 where motion of a dual-hinge closure can be controlled based on determined conditions. At 2210 the DHC is not moving, for example because the DHC is in a closed position. At 2220 a request to open the DHC is received, for example as a signal generated using an input control. At 2230 it is determined whether the vehicle is currently stationary. At 2240 it is determined whether a child protection mode is currently not activated. For example, either or both of these can be done by a local controller for the DHC and/or the vehicle controller 720 (FIG. 7). At 2250 the DHC can be opened provided that the determined conditions are satisfactory.

FIG. 23 shows another example of a method 2300 where motion of a dual-hinge closure can be controlled based on determined conditions. At 2310 the DHC is not moving, for example because the DHC is in a closed position. At 2320 a request to close the DHC is received, for example as a signal generated using an input control. Determinations whether the vehicle is stationary (at 2330) and whether a child protection mode is currently not activated (at 2340) can be performed. At 2350 the DHC can be closed provided that the determined conditions are satisfactory.

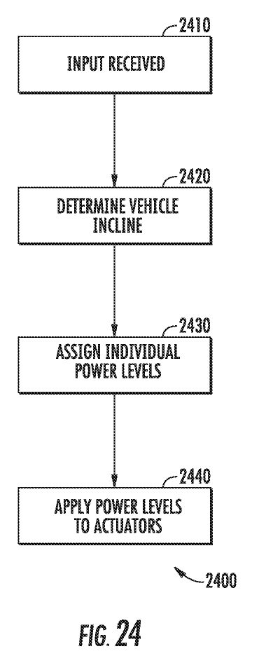

FIG. 24 shows an example of a method 2400 where electric actuators of a dual-hinge closure can be controlled individually. At 2410 a signal to open or close the DHC is received. For example, this can be the result of an input using an internal or external input control. At 2420 a vehicle incline can be determined. In some implementations, this can involve a fore-aft incline and/or a sideways incline, or combinations thereof. For example, if the DHC were to be opened when the vehicle is stopped uphill, the gravitational force on the DHC is in such a direction that it tends to rotate the lower portion of the DHC towards the rear of the vehicle, which could affect the operation of the actuators. At 2430, therefore, individual power levels for the actuators can be assigned. For example, the individual power levels can allocate more power to the actuators on one side of the DHC (e.g., both the upper-portion actuator and the lower-portion actuator on that side) so as to counteract the direction of gravity on the incline. The individual power levels are applied to the actuators at 2440. For example, the power levels can be reassessed multiple times (or continuously during the motion).

The following summarizes operations that can be performed in an embodiment. A method of controlling an opening sequence of a dual-hinge closure comprising first and second portions can include: receiving, in a vehicle, a signal corresponding to a request for opening the dual-hinge closure; in response to the signal (i) releasing a horizontal latch at a distal end of the dual-hinge closure, (ii) energizing a first actuator to hold a bump stop of the first portion against structure of the vehicle, and (iii) energizing a second actuator to horizontally disengage the distal end of the dual-hinge closure; thereafter (iv) energizing the first actuator to rotate the first portion away from the vehicle and (v) energizing the second actuator to instead rotate the second portion toward the vehicle; thereafter, (vi) when the second portion has rotated to a predefined angle with regard to the first portion, instead rotating the second portion away from the vehicle; and thereafter ceasing rotation of the first and second portions when the dual-hinge closure is in an open position. A method of controlling a closing sequence of a dual-hinge closure comprising first and second portions can include: receiving, in a vehicle, a signal corresponding to a request for closing the dual-hinge closure; in response to the signal (i) energizing a first actuator to rotate the first portion toward the vehicle, and (ii) energizing a second actuator to rotate the second portion toward the vehicle; thereafter, when the second portion has rotated to a predefined angle with regard to the first portion, instead rotating the second portion away from the vehicle; thereafter (iii) stopping rotation of the first portion, and (iv) stopping rotation of the second portion; thereafter (v) energizing the first actuator to hold a bump stop of the first portion against structure of the vehicle, and (vi) energizing the second actuator to substantially horizontally engage a distal end of the dual-hinge closure to the vehicle, and (vii) engaging a horizontal latch at the distal end. A method of latching a dual-hinge closure can include: horizontally moving a distal end of the dual-hinge closure toward a lower end of an opening in the vehicle, the distal end and the lower end provided with a latch system that comprises (i) a latch at one of the ends and (ii) a horizontal striker at another of the ends; vertically restricting the distal end of the dual-hinge closure using at least one wedge in the latch system; and horizontally restricting the distal end of the dual-hinge closure by engaging the latch to the striker.

A number of implementations have been described as examples. Nevertheless, other implementations are covered by the following claims.

What is claimed is:

1. A closure system for a vehicle, the closure system comprising:
a dual-hinge closure comprising a first portion hinged to the vehicle by a first hinge, and a second portion hinged to the first portion by a second hinge;
a frame that at least in part surrounds an opening in the vehicle;
an adjustable bump stop subassembly mounted to the first portion, wherein the adjustable bump stop subassembly rests on the frame when the first portion is in a closed position; and
a latch system comprising a latch configured to engage a horizontal striker, the latch system configured so that an end of the second portion opposite the second hinge latches to and unlatches from a distal portion of the frame by essentially horizontal motion.

2. The closure system of claim 1, further comprising first electromechanical actuators for the first portion, and second electromechanical actuators for the second portion.

3. The closure system of claim 2, wherein the first electromechanical actuators extend between a distal end of the first portion and the frame at the first hinge.

4. The closure system of claim 2, wherein the second electromechanical actuators extend between a proximate end of the first portion and a proximate end of the second portion.

5. The closure system of claim 1, wherein the latch is mounted on the end of the second portion, and the horizontal striker is mounted on the distal portion of the frame.

6. The closure system of claim 1, further comprising a striker assembly that comprises the horizontal striker and a wedge configured to engage a nose of the latch.

7. The closure system of claim 6, wherein the striker assembly comprises respective wedges on each side of the horizontal striker.

8. The closure system of claim 6, wherein the striker assembly comprises respective wedges above and below the horizontal striker.

9. The closure system of claim 6, wherein the striker assembly further comprises a spring element backing the wedge.

10. The closure system of claim 1, wherein the adjustable bump stop subassembly comprises a spacer, a bracket connected to the first portion, and an adjustment that adjusts the spacer with regard to the bracket.

11. The closure system of claim 10, wherein the adjustable bump stop subassembly further comprises at least one biasing element that biases the spacer.

12. The closure system of claim 11, wherein the biasing element is configured to bias the spacer toward the member.

13. The closure system of claim 11, wherein the adjustable bump stop subassembly further comprises a member that holds the spacer, the member having at least one foot that holds the biasing element against the bracket.

14. The closure system of claim 13, wherein the member is set to different heights depending on the spacer being adjusted, the member guided by bolts that hold the bracket to the upper portion.

15. The closure system of claim 1, further comprising a shutface switch on an edge of the second portion, the shutface switch configured for controlling motion of the dual-hinge closure.

16. A closure system for a vehicle, the closure system comprising:
a dual-hinge closure comprising a first portion hinged to the vehicle by a first hinge, and a second portion hinged to the first portion by a second hinge;
a frame that at least in part surrounds an opening in the vehicle;
first means, mounted to the first portion, for adjustably supporting the first portion in a closed position; and
second means for latching and unlatching an end of the second portion opposite the second hinge to and from a distal portion of the frame by essentially horizontal motion.

17. The closure system of claim 16, wherein the first means comprises an adjustable bump stop subassembly.

18. The closure system of claim 16, wherein the second means comprises a latch system including a latch configured to engage a horizontal striker.

19. The closure system of claim 18, wherein the latch is mounted on the end of the second portion, and the horizontal striker is mounted on the distal portion of the frame.

20. A closure system for a vehicle, the closure system comprising:
a frame that at least in part surrounds an opening in the vehicle;
a dual-hinge door comprising:
an upper portion hinged to the vehicle by upper hinges at a proximate end of the upper portion;
first and second upper electromechanical actuators that extend between a distal end of the upper portion and the frame at the upper hinges;
adjustable bump stop subassemblies mounted to the upper portion, wherein the adjustable bump stop subassemblies rest on the frame when the upper portion is in a closed position;
a lower portion hinged to the upper portion by lower hinges at an upper end of the lower portion; and
first and second lower electromechanical actuators that extend between the proximate end of the upper portion and a proximate end of the lower portion; and
a latch system configured so that the lower portion latches to and unlatches from the frame by essentially horizontal motion, the latch system comprising:
a latch mounted on a lower end of the lower portion;
a horizontal striker mounted on a lower end of the frame, the horizontal striker configured to horizontally fixate the lower portion when the latch is engaged to the horizontal striker;
sliding wedges above and below a nose of the latch on each side of the horizontal striker, the sliding wedges configured to vertically fixate the lower portion when the latch is engaged to the horizontal striker; and
spring elements that back the sliding wedges.
